(19) United States
(12) Patent Application Publication
(10) Pub. No.: US 2008/0066291 A1
(43) Pub. Date: Mar. 20, 2008

(54) Hazardous substance guarantee acquiring method and system, product manufacturing method and computer-readable program

(75) Inventor: Takao Akai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/705,744

(22) Filed: Feb. 14, 2007

(30) Foreign Application Priority Data
Sep. 20, 2006 (JP) PAT. 2006-254420

(51) Int. Cl. H01S 4/00

(52) U.S. Cl. 29/592; 705/1

(57) ABSTRACT

A hazardous substance guarantee acquiring method acquires a hazardous substance guarantee of a part forming a product. The method registers information that enables a part to be specified in correspondence with information that enables judgement as to whether or not a guarantee has been acquired for the part, merges a parts table indicating parts forming the product at a designing stage and a parts table indicating parts forming the product at a manufacturing stage to create a merged parts table, judges whether or not there exists a part for which the guarantee has not been acquired, within the parts forming the product, by collating the parts indicated on the merged parts table and the parts guaranteed by the registered guarantees, and automatically requests issuance of the guarantee for the part for which the guarantee has not been acquired when it is judged that the guarantee has not been acquired for the part.

### BACKGROUND OF THE INVENTION

1. Field of the Invention

The present invention generally relates to hazardous substance guarantee acquiring methods and systems, product manufacturing methods and computer-readable programs, and more particularly to a hazardous substance guarantee acquiring method and a hazardous substance guarantee acquiring system for acquiring a hazardous substance guarantee such as a guarantee of Restriction of the Use of Certain Hazardous Substances in Electrical and Electronic Equipment (RoHs), and to a product manufacturing method and a computer-readable program that use such a hazardous substance guarantee acquiring method.

The hazardous substance guarantee is also referred to as a hazardous substance report or a hazardous substance certificate, and is issued with respect to parts and the like forming a product. The hazardous substance guarantee is a document which guarantees or certifies that no specified hazardous substance is used in the parts and the like.

The RoHS is a restriction on hazardous substances enforced by the European Union (EU), and stands for “Restriction of the Use of Certain Hazardous Substances in Electrical and Electronic Equipment”. The RoHS guarantee is a document that is issued with respect to the parts and the like and guarantees or certifies that no hazardous substances restricted by the RoHS is used therein. The six hazardous substances restricted by the RoHS are lead (Pb), cadmium (Cd), hexavalent chromium (Cr6), mercury (Hg), Poly-Bromo-Biphenyl (PBB) and Poly-Bromo-Diphenyl-Ether (PBDE).

2. Description of the Related Art

The RoHS guarantee is issued by the parts manufacturer, the parts vendor or the like, with respect to the parts that are used when manufacturing a product. For this reason, when a person in charge of parts acquires the parts for forming the product from the parts manufacturer, the parts vendor or the like, this person must acquire the RoHs guarantee that is issued with respect to each of the parts, register the RoHS guarantee for each of the parts in a guarantee registration and disclosure system, and disclose the RoHS guarantee for each of the parts to a product designer who designs the product. The product designer can confirm on the guarantee registration and disclosure system whether or not the product being designed is formed solely of parts for which the RoHS guarantees have been acquired.

More particularly, the product designer downloads an Engineer-Bill Of Material (E-BOM) which is a parts table indicating the parts forming the product at the designing stage, from a Product Data Management (PDM) system which centrally manages information related to the design and development of the product. The product designer then collates the E-BOM with the RoHS guarantees disclosed by the guarantee registration and disclosure system. If there exists a part which forms the product but for which the RoHS guarantee has not be acquired, the product designer acquires the RoHS guarantee for this part by requesting the person in charge of parts to acquire the missing RoHS guarantee. The Bill Of Material (BOM) includes the E-BOM which is the parts table indicating the parts forming the product at the designing stage, and a Manufacturing-Bill Of Material (M-BOM) which is a parts table indicating the parts forming the product at a manufacturing stage.

Because the RoHS guarantees are acquired by the person in charge of parts from the parts manufacturer, the parts vendor or the like, the RoHS guarantees are basically acquired in units of parts that are purchased (that is, purchasing units). However, since the purchasing unit of the parts is unknown in the E-BOM at the designing stage, it is impossible to judge from the E-BOM whether or not the RoHS guarantee for a certain part needs to be acquired. It is conceivable for the person in charge or parts to predict the purchasing unit of the parts and to acquire the RoHS guarantee for the part based on his prediction, but this conceivable method is undesirable in that the parts may be ordered in excess to cause waste of parts or, the ordered parts may be insufficient to cause a need to re-order the parts and also cause a delay in manufacturing the product.

On the other hand, even for the same part forming the product that is to be manufactured, the material, the indirect or subsidiary materials such as adhesive agent and solder, processing applied thereon, the manufacturer, the cost and the like may be different among available parts. Even in a case where the product to be manufactured includes a specified part having the material, indirect or subsidiary materials, the processing applied thereon, the manufacturer, the cost and the like that are specified, the person in charge of parts cannot judge whether or not the product to be manufactured includes the specified part because the E-BOM at the designing stage does not include such information related to the specified part. Hence, the person in charge of parts cannot judge whether or not the RoHS guarantee has been acquired for the specified part. Particularly when the specified part is assembled from a plurality of parts, the parts manufacturer or the parts vendor who provides this specified part in most cases does not issue the RoHS guarantee for this specified part. Consequently, the person in charge of parts must acquire the RoHS guarantee for each of the parts forming this specified part from the manufacturer of this specified part and/or the manufacturer of each part forming this specified part.

Furthermore, even if the RoHS guarantee has been acquired with respect to a predetermined part forming the product, the receiver of order for the predetermined part may be changed for cost reasons and the like. When such a change occurs, the RoHS guarantee that has been acquired is no longer valid, and it becomes necessary to newly acquire the RoHS guarantee with respect to the predetermined part from the new receiver of order.

Therefore, the person in charge or parts must manually carry out the troublesome and time-consuming process of judging whether or not the RoHS guarantee has been acquired with respect to each of the parts forming the product and acquiring the RoHS guarantee that has not yet been acquired.

For example, a Japanese Laid-Open Patent Application No. 2002-259403 proposes a method of evaluating the hazardous substance used within the product, and a Japanese Laid-Open Patent Application No. 2005-309674 proposes a method of judging the similarity of a report for a part with respect to a report for a similar part and evaluating the reliability of the report for the part.

As described above, the hazardous substance guarantee such as the RoHS guarantee that is used with respect to each part forming the product that is to be manufactured is manually acquired by the person in charge of parts. For this reason, there were problems in that the person in charge must manually carry out the troublesome and time-consuming process of acquiring the hazardous substance guarantee, and that it is difficult to manage the hazardous substance guarantees for the parts forming the product since the person in charge of parts is relied upon for such a management.

### SUMMARY OF THE INVENTION

Accordingly, it is a general object of the present invention to provide a novel and useful hazardous substance guarantee acquiring method and system, product manufacturing method and computer-readable program, in which the problems described above are suppressed.

Another and more specific object of the present invention is to provide a hazardous substance guarantee acquiring method, a hazardous substance guarantee acquiring system, a product manufacturing method and a computer-readable program, which can automatically acquire a hazardous substance guarantee such as a RoHS guarantee that is issued with respect to each part forming a product that is to be manufactured, and easily manage the existence of the hazardous substance guarantee for the parts forming the product.

Still another object of the present invention is to provide a hazardous substance guarantee acquiring method to be implemented in a computer system which has a processor and a storage part and to acquire a hazardous substance guarantee of a part forming a product, comprising a registering step registering, in the storage part, information that enables a part to be specified, in correspondence with information that enables judgement as to whether or not a hazardous substance guarantee has been acquired for the part; a merging step merging, by the processor, a parts table indicating parts forming the product at a designing stage and a parts table indicating parts forming the product at a manufacturing stage, and creating a merged parts table; a judging step judging, by the processor, whether or not there exists a part for which the hazardous substance guarantee has not been acquired, within the parts forming the product, by collating the parts indicated on the merged parts table and the parts guaranteed by the hazardous substance guarantees registered in the storage part; and a requesting step automatically requesting, by the processor, an issuance of the hazardous substance guarantee for the part for which the hazardous substance guarantee has not been acquired when the judging step judges that the hazardous substance guarantee has not been acquired for the part. According to the hazardous substance guarantee acquiring method of the present invention, it is possible to automatically acquire the hazardous substance guarantee such as a RoHS guarantee that is issued with respect to each part forming the product that is to be manufactured, and easily manage the existence of the hazardous substance guarantee for the parts forming the product.

A further object of the present invention is to provide a hazardous substance guarantee acquiring system for acquiring a hazardous substance guarantee of a part forming a product, comprising a guarantee database part configured to register information that enables a part to be specified, in correspondence with information that enables judgement as to whether or not a hazardous substance guarantee has been acquired for the part; a merging part configured to merge a parts table indicating parts forming the product at a designing stage and a parts table indicating parts forming the product at a manufacturing stage, and to create a merged parts table; a searching part configured to collate the parts indicated on the merged parts table and the parts guaranteed by the hazardous substance guarantees registered in the storage part, and to search the parts registered in the guarantee database part; a judging part configured to judge whether or not there exists a part for which the hazardous substance guarantee has not been acquired, within the parts forming the product, based on a search result of the searching part; and a requesting part configured to automatically request an issuance of the hazardous substance guarantee for the part for which the hazardous substance guarantee has not been acquired when the judging part judges that the hazardous substance guarantee has not been acquired for the part. According to the hazardous substance guarantee acquiring system of the present invention, it is possible to automatically acquire the hazardous substance guarantee such as a RoHS guarantee that is issued with respect to each part forming the product that is to be manufactured, and easily manage the existence of the hazardous substance guarantee for the parts forming the product.

Another object of the present invention is to provide a product manufacturing method comprising a product planning procedure planning a product; a developing and designing procedure developing and designing the planned product; and a trial and actual manufacturing procedure making the developed and designed product by a trial manufacture and an actual manufacture, wherein a hazardous substance guarantee is acquired for each of parts forming the product by a hazardous substance guarantee acquiring system in at least one of the product planning procedure, the developing and designing procedure, and the trial and actual manufacturing procedure, and the hazardous substance guarantee acquiring system comprises a guarantee database part configured to register information that enables a part to be specified, in correspondence with information that enables judgement as to whether or not a hazardous substance guarantee has been acquired for the part; a merging part configured to merge a parts table indicating parts forming the product at a designing stage and a parts table indicating parts forming the product at a manufacturing stage, and to create a merged parts table; a searching part configured to collate the parts indicated on the merged parts table and the parts guaranteed by the hazardous substance guarantees registered in the storage part, and to search the parts registered in the guarantee database part; a judging part configured to judge whether or not there exists a part for which the hazardous substance guarantee has not been acquired, within the parts forming the product, based on a search result of the searching part; and a requesting part configured to automatically request an issuance of the hazardous substance guarantee for the part for which the hazardous substance guarantee has not been acquired when the judging part judges that the hazardous substance guarantee has not been acquired for the part. According to the product manufacturing method of the present invention, it is possible to automatically acquire the hazardous substance guarantee such as a RoHS guarantee that is issued with respect to each part forming the product that is to be manufactured, and easily manage the existence of the hazardous substance guarantee for the parts forming the product.

Still another object of the present invention is to provide a computer-readable program for causing a computer to acquire a hazardous substance guarantee of a part forming a product, the computer being accessible to a guarantee database part configured to register information that enables a part to be specified, in correspondence with information that enables judgement as to whether or not a hazardous substance guarantee has been acquired for the part, the computer-readable program comprising a merging procedure causing the computer to merge a parts table indicating parts forming the product at a designing stage and a parts table indicating parts forming the product at a manufacturing stage, and to create a merged parts table; a searching procedure causing the computer to collate the parts indicated on the merged parts table and the parts guaranteed by the hazardous substance guarantees registered in the storage part, and to search the parts registered in the guarantee database part; a judging procedure causing the computer to judge whether or not there exists a part for which the hazardous substance guarantee has not been acquired, within the parts forming the product, based on a search result of the searching procedure; and a requesting procedure causing the computer to automatically request an issuance of the hazardous substance guarantee for the part for which the hazardous substance guarantee has not been acquired when the judging procedure judges that the hazardous substance guarantee has not been acquired for the part. According to the computer-readable program of the present invention, it is possible to automatically acquire the hazardous substance guarantee such as a RoHS guarantee that is issued with respect to each part forming the product that is to be manufactured, and easily manage the existence of the hazardous substance guarantee for the parts forming the product.

Other objects and further features of the present invention will be apparent from the following detailed description when read in conjunction with the accompanying drawings.

### BRIEF DESCRIPTION OF THE DRAWINGS

FIG. 1 is a system block diagram showing a general structure of a hazardous substance guarantee acquiring system to which the present invention is applied;

FIG. 2 is a system block diagram showing the structure of the hazardous substance guarantee acquiring system in more detail;

FIG. 3 is a flow chart for explaining a hazardous substance guarantee acquiring process;

FIG. 4 is a diagram showing a data structure of user information;

FIG. 5 is a diagram showing a data structure of data related to registered RoHS guarantees;

FIG. 6 is a flow chart for explaining a BOM registering process for a specified part;

FIG. 7 is a flow chart for explaining a hazardous substance guarantee re-acquiring process when changing the receiver of order;

FIG. 8 is a flow chart for explaining an automatic distribution process for distributing standards of parts and the like; and

FIG. 9 is a flow chart for explaining a product manufacturing method.

### DESCRIPTION OF THE PREFERRED EMBODIMENTS

A description will be given of embodiments of the hazardous substance guarantee acquiring method and system, product manufacturing method and computer-readable program according to the present invention, by referring to the drawings.

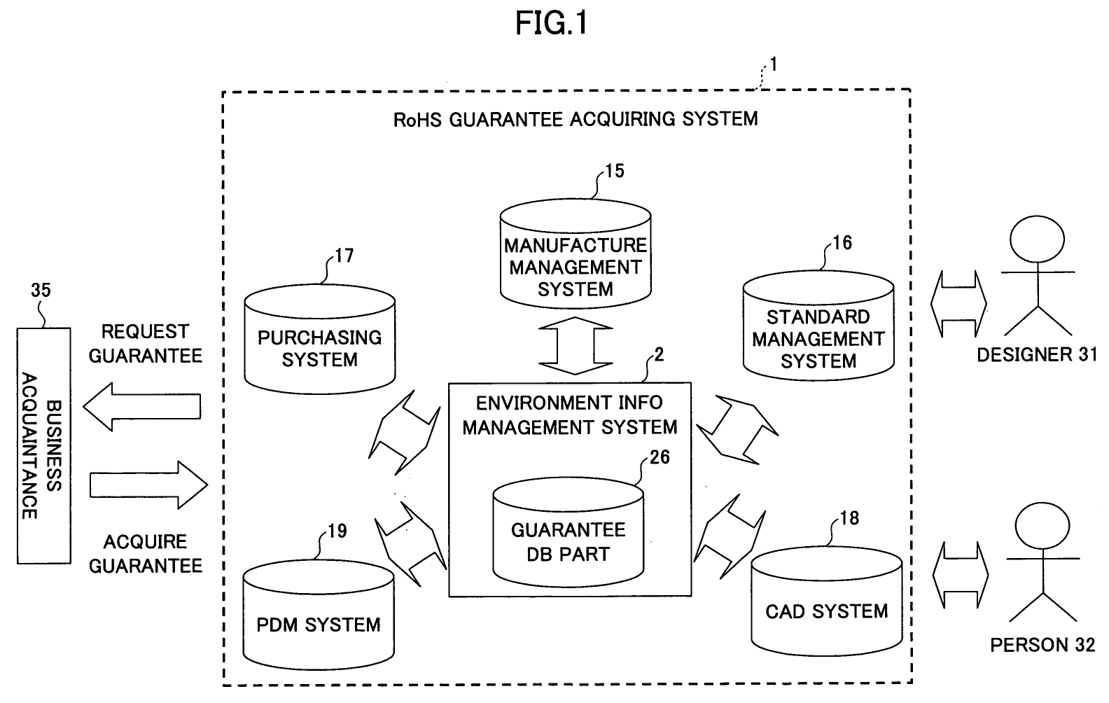

FIG. 1 is a system block diagram showing a general structure of the hazardous substance guarantee acquiring system to which the present invention is applied. If the following description, it is assumed for the sake of convenience that the hazardous substance guarantee is an RoHS guarantee.

An RoHS guarantee acquiring system 1, which is a hazardous substance guarantee acquiring system, includes an environment information management system 2, a manufacture management system 15, a standard management system 16, a purchasing system 17, a Computer Aided Design (CAD) system 18, and a Product Data Management (PDM) system 19. The environment information management system 2 includes a guarantee database (DB) part 26, and is capable of making access to the manufacture management system 15, the standard management system 16, the purchasing system 17, the CAD system 18 and the PDM system 19. The manufacture management system 15 manages a state of manufacture of the products that are to be produced, and includes a Manufacturing-Bill Of Material (M-BOM) which is a parts table indicating the parts forming the product at the manufacturing stage. The standard management system 16 manages information related to the standards of the products that are to be produced and the standards of each of the parts forming the products that are to be produced. The purchasing system 17 manages information related to the purchase of each of the parts forming the products that are to be produced, and includes information related to a business acquaintance or the like. The CAD system 18 designs the products that are to be produced based on inputs or the like made by a product designer 31. The PDM system 19 centrally manages information related to the design and development of the products, and includes an Engineering-Bill Of Material (E-BOM) which is a parts table indicating the parts forming the product at the designing stage. The guarantee database part 26 registers and manages the RoHS guarantees that have been acquired for the parts.

The environment information management system 2 may be formed by a computer system such as a Web server, and has a known hardware structure including a processor such as a CPU, a storage part and the like.

The product designer 31 can make access to the guarantee database part 26 of the environment information management system 2, and confirm whether or not the product that is being designed is formed solely from the parts for which the RoHS guarantees have already been acquired. A person 32 in charge of parts (or specification) can make access to the guarantee database part 26 of the environment information management system 2, and confirm whether or not the RoHS guarantee has been acquired for a certain part. In response to an operation of the RoHS guarantee acquiring system 1 made by the product designer 31 or the person 32 in charge of parts, if the RoHS guarantee for a certain part forming the product is not registered in the RoHS guarantee database part 26, the RoHS guarantee acquiring system 1 automatically requests the issuance of the RoHS guarantee for this certain part to a business acquaintance 35 based on information of the parties one does business with managed by the purchasing system 17, and registers the RoHS guarantee that is acquired from the business acquaintance 35 into the guarantee database part 26. More particularly, the environment information management system 2 collates the parts that are indicated on a merged parts table that is obtained by merging the M-BOM acquired from the manufacture management system 15 and the E-BOM acquired from the PDM system 19, with the parts that are guaranteed by the RoHS guarantees registered in the guarantee database part 26. If the RoHS guarantee for one of the parts forming the product has not yet been acquired, the RoHS guarantee acquiring system 1 requests the business acquaintance 46 to issue the RoHS guarantee for this one part and automatically acquires the RoHS guarantee for this one part from the business acquaintance 46. The RoHs guarantee acquiring system 1 registers the acquired RoHS guarantee for this one part into the guarantee database part 26.

Presently, the RoHS guarantees are sent in the form of documents. For this reason, the contents of the RoHS guarantee that is acquired from the business acquaintance 35 are converted into electronic data by the person 32 or the like and registered into the guarantee database part 26. However, if the RoHS guarantees are sent in the form of electronic data in the future, the contents (electronic data) of the RoHS guarantee that is acquired from the business acquaintance 35 may be registered as they are into the guarantee database part 26 by obtaining approval by the person 32 or the like if necessary.

An embodiment of the hazardous substance guarantee acquiring method according to the present invention is executed by the RoHS guarantee acquiring system 1.

An embodiment of the hazardous substance guarantee acquiring system according to the present invention is formed by the RoHS guarantee acquiring system 1.

An embodiment of the product manufacturing method according to the present invention manufactures the product using the embodiment of the hazardous substance guarantee acquiring method or system according to the present invention.

An embodiment of the computer-readable program according to the present invention causes a computer or computer system forming the environment information management system 2 to execute the embodiment of the hazardous substance guarantee acquiring method according to the present invention.

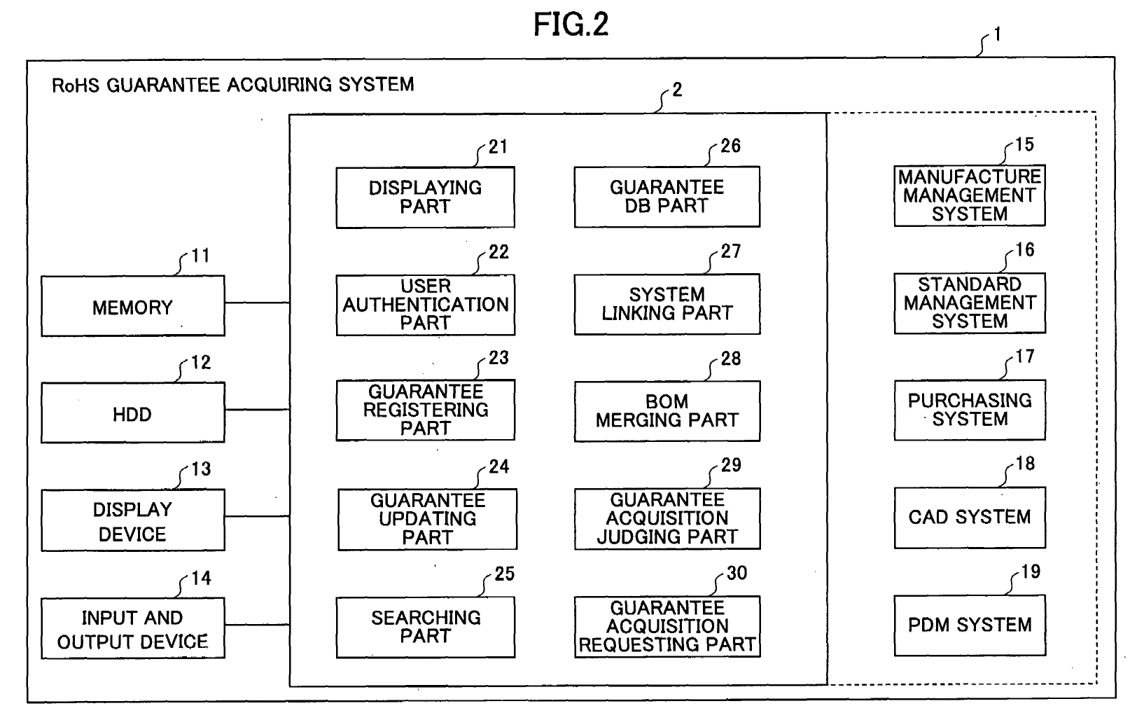

FIG. 2 is a system block diagram showing the structure of the hazardous substance guarantee acquiring system in more detail. For the sake of convenience, FIG. 2 shows the structure of the RoHS guarantee acquiring system 1 in the form of functional blocks.

As shown in FIG. 2, the environment information management system 2 has a display part 21, a user authenticating part 22, a guarantee registering part 23, a guarantee updating part 24, a searching part 25, the guarantee database part 26, a system linking part 27 for linking to other systems, a BOM merging part 28, a guarantee acquisition judging part 29, and a guarantee acquisition requesting part 30.

A memory 11, a Hard Disk Drive (HDD) 12, a display device 13 and an input and output device 14 are connected to the environment information management system 2. The memory 11 and the HDD 12 form a storage part for storing programs that are executed by the environment information management system 2 and various data including intermediate data of operations executed by the programs. The display device 13 displays a screen for operating the environment information management system 2 and a screen for indicating search results of the parts table and the like. The input and output device 14 includes an input device and an output device. The input device is formed by a keyboard, a mouse or the like that are operated by the product designer 31 or the person 32 when inputting instructions and data to the environment information management system 2. The output device is formed by a printer or the like that outputs the search results and the like. Of course, the screen that is displayed on the display device 13 may be displayed on a display device of another computer system that is connected to the RoHS guarantee acquiring system 1 via a network.

As long as the manufacture management system 15, the standard management system 16, the purchasing system 17, the CAD system 18 and the PDM system 19 are accessible from the environment information management system 2, the manufacture management system 15, the standard management system 16, the purchasing system 17, the CAD system 18 and the PDM system 19 may be included within the environment information management system 2 as indicated by broken lines in FIG. 2.

The displaying part 21 controls the display to be made on the display device 13, and may be formed by a known graphic interface or the like. The user authenticating part 22 carries out a user authentication with respect to the product designer 31 or the person 32 according to a known method, based on a personal identification number, a password or the like that is input from the input device. The guarantee registering part 23 registers the RoHS guarantee that is acquired from the business acquaintance 35 into the guarantee database part 26, based on information input by the person 32 from the input device. The guarantee updating part 24 updates the RoHS guarantee that is registered in the guarantee database part 26, based on information input by the person 32 from the input device depending on a change or the like of the part to be used for the product. The searching part 25 carries out various searches with respect to the guarantee database part 26, based on information input by the product designer 31 or the person 32 from the input device. The guarantee database part 26 registers the RoHS guarantee of the part, which has already been acquired, based on information input by the person 32 from the input device. The system linking part 27 controls exchanges between the environment information management system 2 and each of the manufacture management system 15, the standard management system 16, the purchasing system 17, the CAD system 18 and the PDM system 19. The BOM merging part 28 creates the merged parts table by merging the M-BOM acquired from the manufacture management system 15 and the E-BOM acquired from the PDM system 19. The guarantee acquisition judging part 29 uses the merged parts table based on information input by the product designer 31 or the person 32 from the input device, and judges the existence of the RoHS guarantee, that is, whether or not the RoHS guarantee needs to be acquired, depending on whether or not the RoHS guarantee for a certain part is registered in the guarantee database part 26. The guarantee acquisition requesting part 30 automatically requests issuance of the RoHS guarantee for the certain part to the business acquaintance 35 if the guarantee acquisition judging part 29 judges that the RoHS guarantee for this certain part needs to be acquired. The guarantee acquisition requesting part 30 automatically requests the issuance of the RoHS guarantee for this certain part to the business acquaintance 35 by a communication means such as electronic mail, facsimile, telephone, mail or the like. When requesting the issuance of the RoHS guarantee to the business acquaintance 35 by electronic mail, facsimile or telephone, the guarantee acquisition requesting part 30 includes a communicating part (or transmitting and receiving part) for communicating with the business acquaintance 35 by the electronic mail, facsimile or telephone. On the other hand, when requesting the issuance of the RoHS guarantee to the business acquaintance 35 by mail, the guarantee acquisition requesting part 30 includes a print instructing part for instructing the printer to print a post card or the like that is to be mailed to the business acquaintance 35.

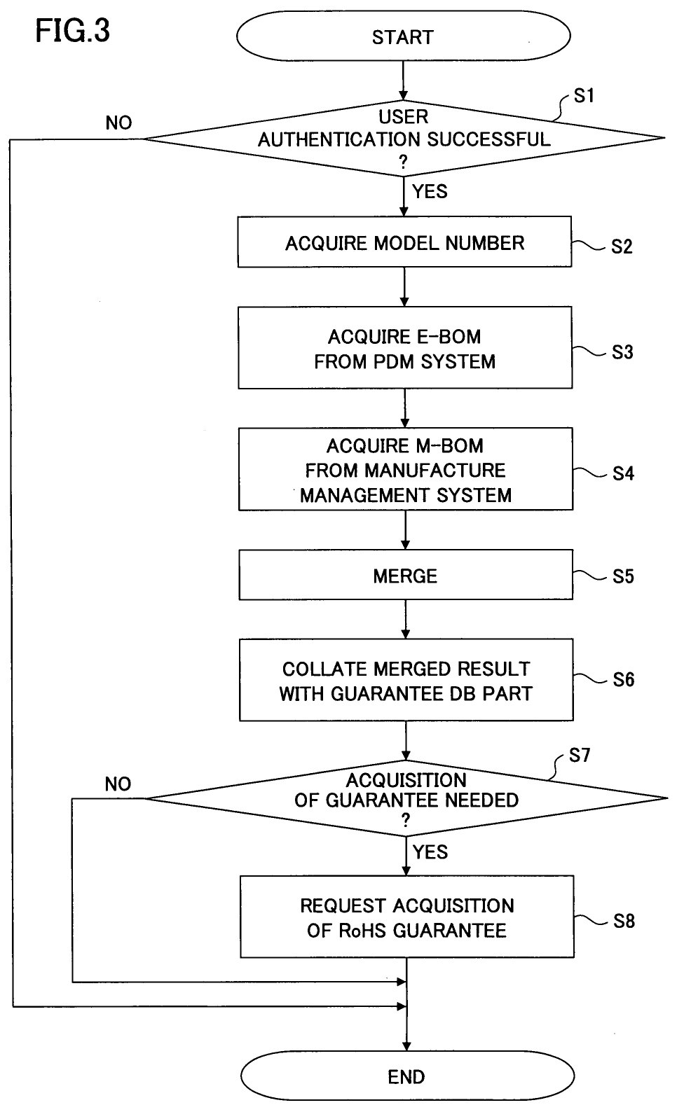

FIG. 3 is a flow chart for explaining a hazardous substance guarantee acquiring process. The process shown in FIG. 3 is executed by the environment information management system 2.

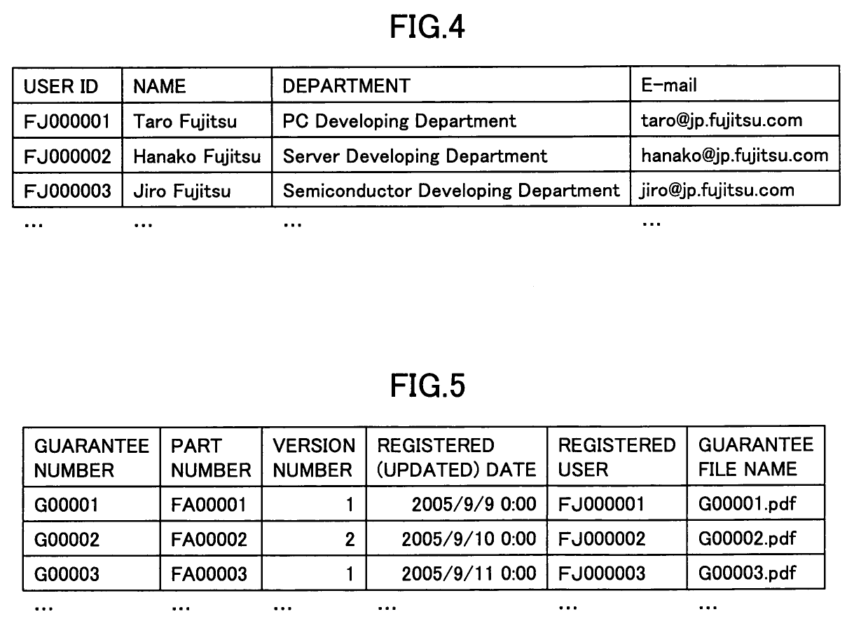

In FIG. 3, a step Si carries out a user authentication by the user authentication part 22 to judge whether or not the user who is attempting to access the environment information management system 2 is a registered and authorized (or legitimate) user. In this case, the user authentication part 22 carries out the user authentication with respect to the product designer 31 or the person 32, by collating the information that is input from the input device and is peculiar to the user, such as a user ID, with the user information that is registered in advance within the user authentication part 22 or the storage part such as the memory 11. FIG. 4 is a diagram showing a data structure of the user information. The user information shown in FIG. 4 includes the user ID, the name of user, the department to which the user belongs, and the electronic mail (E-mail) address. If the judgement result in the step S1 is YES, the process advances to a step S2. On the other hand, the process ends if the judgement result in the step S1 is NO. The user information needs to include at least the information that is peculiar to the user and enables the user to be specified therefrom.

A step S2 acquires a model number (or product number) of a target product that is being designed and is to be manufactured, from the CAD system 18, by the system linking part 27. For example, when the user inputs the product name, the product-code or the like of the target product from the input device, the system linking part 27 acquires the corresponding model number from the CAD system 18. Of course, the user may input the model number of the target product directly from the input device.

A step S3 acquires the E-BOM corresponding to the model number of the target product, from the PDM system 19, by the system linking part 27.

A step S4 acquires the M-BOM corresponding to the model number of the target product, from the manufacture management system 15, by the system linking part 27.

A step S5 merges the E-BOM acquired in the step S3 and the M-BOM acquired in the step S4 and creates the merged parts table, by the BOM merging part 28. Since the merged parts table includes the contents of the M-BOM of the target product, the purchasing unit of the parts forming the target product is clear from the merged parts table.

The RoHS guarantees are basically acquired in units of parts that are purchased (that is, purchasing units). However, since the purchasing unit of the parts is unknown in the E-BOM at the designing stage, it is impossible to judge from the E-BOM whether or not the RoHS guarantee for a certain part needs to be acquired. It is conceivable for the person in charge or parts to predict the purchasing unit of the parts and to acquire the RoHS guarantee for the part based on his prediction, but this conceivable method is undesirable in that the parts may be ordered in excess to cause waste of parts or, the ordered parts may be insufficient to cause a need to re-order the parts and also cause a delay in manufacturing the product. But this embodiment creates the merged parts table by merging the E-BOM and the M-BOM, and thus, it is possible to judge the existence of the RoHS guarantee for a certain part, that is, judge whether or not the RoHS guarantee for the certain part needs to be acquired, based on this merged parts table.

A step S6 searches the guarantee database part 26 by the searching part 25, based on the merged parts table. Hence, the parts indicated on the merged parts table and the parts guaranteed by the RoHS guarantees registered in the guarantee database part 26 are collated. Accordingly, it becomes clear whether or not the RoHS guarantee is already acquired for each of the parts forming the target product.

FIG. 5 is a diagram showing a data structure of data related to the registered RoHS guarantees that are registered in the guarantee database part 26. The data related to the registered RoHS guarantees shown in FIG. 5 include the guarantee number that is given to and is peculiar to each RoHS guarantee, the part number that is given to and is peculiar to each part, the version number of the data, the registered date (or updated date) of the data, the user (registered user) who registered the data, and the guarantee file name that includes the contents of the RoHS guarantee. The information that is registered in the guarantee database part 26 needs to include at least the information such as the part number which enables the part to be specified, and the information such as the guarantee number which enables the user (for example, the product designer 31 or the person 32) to judge that the RoHS guarantee for the certain part has already been acquired.

A step S7 judges whether or not to it is necessary to acquire the RoHS guarantee for a part, by the guarantee acquisition judging part 29, depending on whether or not there exists a part for which the RoHS guarantee has not been acquired as a result of the search carried out in the step S6. The process ends if the RoHS guarantee has been acquired for all of the parts forming the target product and the judgement result in the step S7 is NO. On the other hand, if there exists a part for which the RoHS guarantee has not been acquired and the judgement result in the step S7 is YES, the process advances to a step S8.

If there exists a part for which the RoHS guarantee has not be acquired as a result of the judgement made in the step S7 and it is necessary to acquire the RoHS guarantee for this part, the step S8 automatically requests the issuance of the RoHS guarantee for this part to the business acquaintance. 35 by the guarantee acquisition requesting part 30, by the communication means such as the electronic mail, facsimile, telephone and mail, based on the information related to the business acquaintance 35 managed by the purchasing system 17. The process ends after the step S8.

On the other hand, even for the same part forming the target product that is to be manufactured, the material, the indirect or subsidiary materials such as adhesive agent and solder, processing applied thereon, the manufacturer, the cost and the like may be different among the available parts. Even in a case where the target product includes a specified part having the material, indirect or subsidiary materials, the processing applied thereon, the manufacturer, the cost and the like that are specified, the user such as the person 32 cannot judge whether or not the target product includes the specified part because the E-BOM at the designing stage does not include such information related to the specified part. Hence, the user cannot judge whether or not the RoHS guarantee has been acquired for the specified part. Particularly when the specified part is assembled from a plurality of parts, the parts manufacturer or the parts vendor who provides this specified part in most cases does not issue the RoHS guarantee for this specified part. Consequently, the user must acquire the RoHS guarantee for each of the parts forming this specified part from the manufacturer of this specified part and/or the manufacturer of each part forming this specified part.

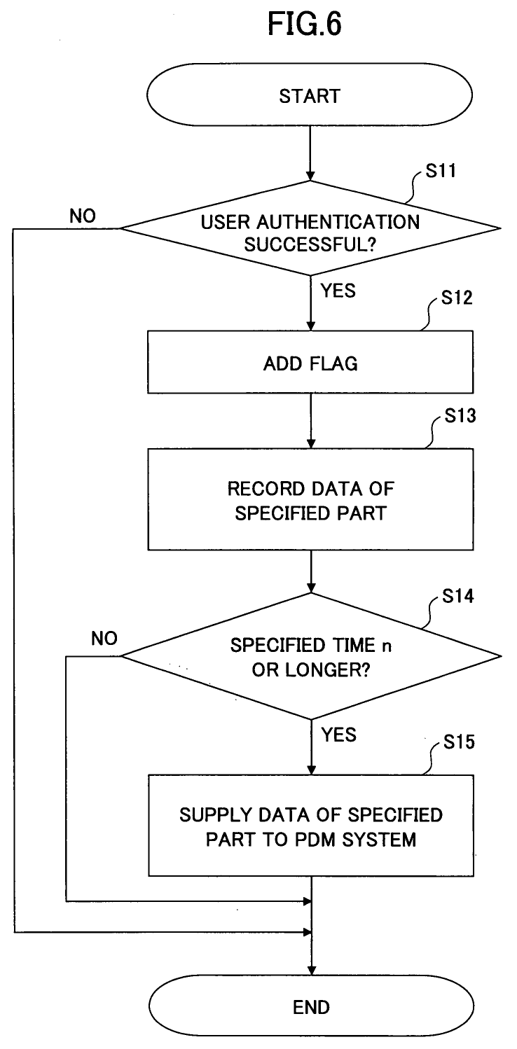

FIG. 6 is a flow chart for explaining a BOM registering process for a specified part. The process shown in FIG. 6 is executed by the environment information management system 2.

In FIG. 6, a step S11 carries out a user authentication by the user authentication part 22 to judge whether or not the user who is attempting to access the environment information management system 2 is a registered and authorized (or legitimate) user. This user authentication may be carried out similarly to the step S1 shown in FIG. 3. The process advances to a step S12 if the judgement result in the step S11 is YES, and the process ends if the judgement result in the step S11 is NO.

If the part for which the issuance of the RoHS guarantee is to be requested to the business acquaintance 35 is a specified part, the step S12 adds a flag to the data of this specified part to indicate that this part is a specified part, by the guarantee acquisition requesting part 30. For example, whether or not the part is a specified part may be designated by the user from the input device.

A step S13 records the data of the specified part, added with the flag, in the guarantee database part 26, by the guarantee acquisition requesting part 30. For example, it is possible to provide a field for storing the flag in correspondence with the part number, in addition to the data shown in FIG. 5. Furthermore, the data of the specified part, added with the flag, may be recorded within the environment information management system 2, including the guarantee acquisition requesting part 30, or the storage part such as the memory 11.

A step S14 judges whether or not an elapsed time from the recording of the data of the specified part, added with the flag, is a specified time n or longer, by the guarantee updating part 24. The process advances to a step S15 if the judgement result in the step S14 is YES, and the process ends if the judgement result in the step S14 is NO. The specified time n may be preset as a default value or, may be input by the user from the input device.

The step S15 judges that the designation of the specified part has become definite because the elapsed time from the recording of the data of the specified part, added with the flag, is the specified time n or longer, and supplies the data of the specified part, added with the flag, to the PDM system 19 by the system linking part 27, so as to reflect the data to the E-BOM within the PDM system 19. The process ends after the step S15.

Even if the RoHS guarantee has been acquired with respect to a predetermined part forming the target product, the receiver of order for the predetermined part, such as the parts manufacturer or the parts vendor, may be changed for cost reasons and the like. When such a change occurs, the RoHS guarantee that has been acquired is no longer valid, and it becomes necessary to newly acquire the RoHS guarantee with respect to the predetermined part from the new receiver of order.

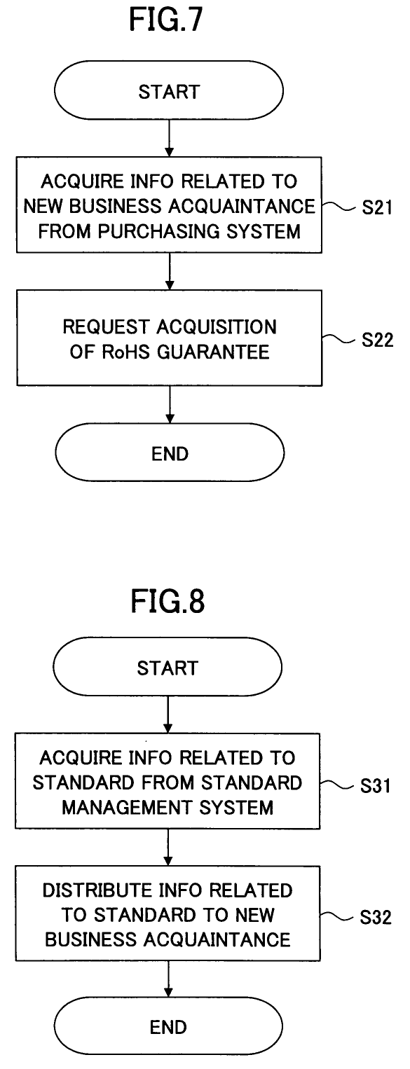

FIG. 7 is a flow chart for explaining a hazardous substance guarantee re-acquiring process when changing the receiver of order. The process shown in FIG. 7 is executed by the environment information management system 2.

In FIG. 7, a step S21 detects a change in the receiver of order based on information input by the user from the input device, and by using this detection of the change as a trigger, acquires information related to the new receiver of order (that is, information related to the new business acquaintance) to which the issuance of the RoHS guarantee is to be newly requested based on the information related to the business acquaintance managed by the purchasing system 17, by the system linking part 27.

A step S22 automatically requests the issuance of the RoHS guarantee for the part for which the change of receiver of order has occurred, to the new business acquaintance which is different from the business acquaintance 35, by the guarantee acquisition requesting part 30, by the communication means such as the electronic mail, facsimile, telephone and mail, based on the information related to the new business acquaintance managed by the purchasing system 17. The process ends after the step S22.

The guarantee updating part 24 updates the RoHS guarantees that are registered in the guarantee database part 26, based on information input by the user from the input device when a part to be used for the target product is added or changed, a specified part is to be used for the target product or, the receiver of order is changed to the new business acquaintance.

When automatically requesting the issuance of the RoHS guarantee for a certain part from the RoHS guarantee acquisition system 1 to the business acquaintance 35, the certain part itself is also ordered. For this reason, it is desirable to provide information related to the standard of the certain part to the business acquaintance 35 when automatically requesting the issuance of the RoHS guarantee for this certain part to the business acquaintance 35.

FIG. 8 is a flow chart for explaining an automatic distribution process for distributing the standards of the parts and the like. The process shown in FIG. 8 is executed by the environment information management system 2.

In FIG. 8, with respect to a part for which the issuance of the RoHS guarantee is requested from the guarantee acquisition requesting part 30, a step S31 acquires the information related to the standard of this part from the standard management part 16 by the system linking part 27. In this case, the part for which the RoHS guarantee is requested from the guarantee acquisition requesting part 30 may be the part that is specified by the user from the input device or, the part for which the guarantee acquisition judging part 29 judges that the RoHS guarantee needs to be acquired.

A step S32 automatically distributes the information related to the standard of the part for which the issuance of the RoHS guarantee is to be requested to the business acquaintance 35 by the guarantee acquisition requesting part 30, by the communication means such as the electronic mail, facsimile, telephone and mail, based on the information related to the business acquaintance 35 managed by the purchasing system 17. The process ends after the step S32. The information related to the standard of the part may be sent together with the request to issue the RoHS guarantee or, separately from the request to issue the RoHS guarantee. In the latter case, the information related to the standard of the part may be sent by a communication means different from that used to send the request to issue the RoHS guarantee.

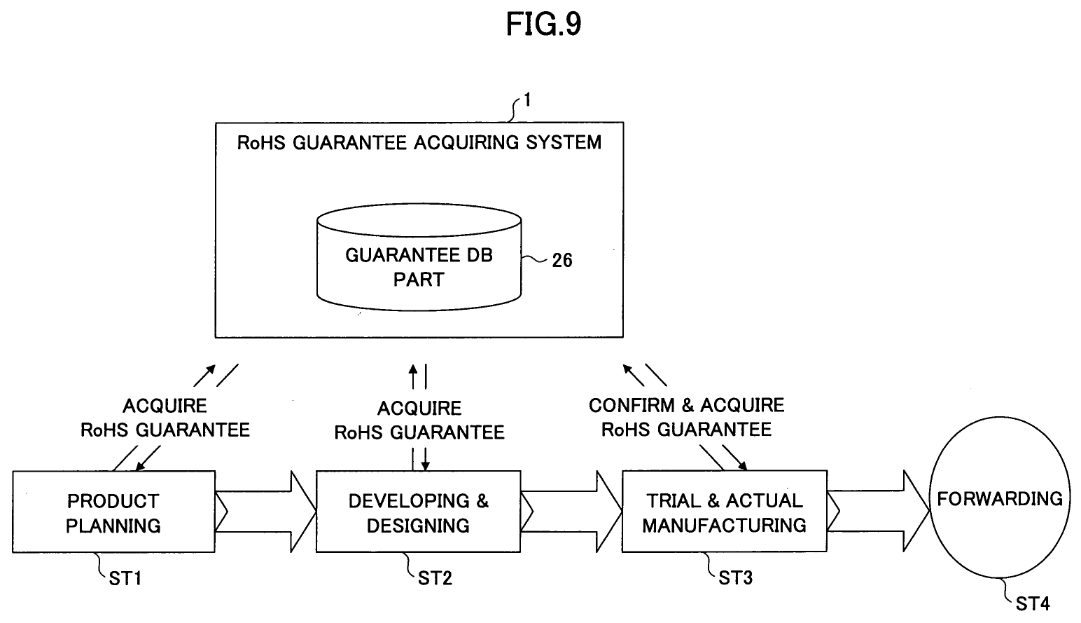

FIG. 9 is a flow chart for explaining a product manufacturing method. The product manufacturing method shown in FIG. 9 generally includes a product planning procedure ST1, a developing and designing procedure ST2, a trial and actual manufacturing procedure ST3, and a forwarding procedure ST4.

In the product planning procedure ST1, the planner and/or the product designer 31 plans the product that is to be manufactured, and lists up the parts to be used for the product at the planning stage. The RoHS guarantee acquisition system 1 is utilized to automatically request the issuance of the RoHS guarantees for the parts and to acquire the RoHS guarantees, based on the list of parts used by the person 32, for example.

In the developing and designing procedure ST2, the product designer 31 develops and designs the planned product, and lists up the parts to be used for the product at the developing and designing stage. The RoHS guarantee acquisition system 1 is utilized to automatically request the issuance of the RoHS guarantees for the parts and to acquire the RoHS guarantees, based on the list of parts used by the person 32, for example.

In the trial and actual manufacturing procedure ST3, the developed and designed product is made by the trial manufacture and the actual manufacture. If there exists a certain part for which the RoHS guarantee has not yet been acquired in the trial and actual manufacturing stage, person 32, for example, utilizes the RoHS guarantee acquisition system 1 to automatically request the issuance of the RoHS guarantee for this certain part and to acquire the RoHS guarantee. More particularly, the person 32 utilizes the RoHS guarantee acquisition system 1 to confirm whether or not the RoHS guarantees of all of the parts to be used for the product in the trial and actual manufacturing stage have already been acquired, and if there exists a certain part for which the RoHS guarantee has not yet been acquired, the person 32 utilizes the RoHS guarantee acquisition system 1 to automatically request the issuance of the RoHS guarantee for this certain part and to acquire the RoHS guarantee.

In the procedures ST1 through ST3, the RoHS guarantees that are automatically requested and acquired are registered in the RoHS guarantee acquisition system 1 depending on the operation made by the person 32, to update the registered contents of the guarantee database part 26.

In the forwarding procedure ST4, the product that is actually manufactured using the parts for which the RoHS guarantees have been acquired is forwarded to be distributed and sold.

This application claims the benefit of a Japanese Patent Application No. 2006-254420 filed Sep. 20, 2006, in the Japanese Patent Office, the disclosure of which is hereby incorporated by reference.

Further, the present invention is not limited to these embodiments, but various variations and modifications may be made without departing from the scope of the present invention.

What is claimed is:

1. A hazardous substance guarantee acquiring method to be implemented in a computer system which has a processor and a storage part and to acquire a hazardous substance guarantee of a part forming a product, comprising:
a registering step registering, in the storage part, information that enables a part to be specified, in correspondence with information that enables judgement as to whether or not a hazardous substance guarantee has been acquired for the part;
a merging step merging, by the processor, a parts table indicating parts forming the product at a designing stage and a parts table indicating parts forming the product at a manufacturing stage, and creating a merged parts table;
a judging step judging, by the processor, whether or not there exists a part for which the hazardous substance guarantee has not been acquired, within the parts forming the product, by collating the parts indicated on the merged parts table and the parts guaranteed by the hazardous substance guarantees registered in the storage part; and
a requesting step automatically requesting, by the processor, an issuance of the hazardous substance guarantee for the part for which the hazardous substance guarantee has not been acquired when the judging step judges that the hazardous substance guarantee has not been acquired for the part.

2. The hazardous substance guarantee acquiring method as claimed in claim 1, wherein the requesting step acquires from a purchasing system, by the processor, information related to a business acquaintance that provides the part and automatically requests the issuance of the hazardous substance guarantee for the part to the business acquaintance based on the information related to the business acquaintance.

3. The hazardous substance guarantee acquiring method as claimed in claim 2, wherein the requesting step acquires from a standard managing system, by the processor, information related to standards of the parts forming the product and automatically distributes the information related to the standard of the part for which the issuance of the hazardous substance guarantee is requested to the business acquaintance based on the information related to the business acquaintance.

4. The hazardous substance guarantee acquiring method as claimed in claim 2, wherein the requesting step requests the issuance of the hazardous substance guarantee to the business acquaintance by electronic mail, facsimile, telephone or mail.

5. The hazardous substance guarantee acquiring method as claimed in claim 1, wherein the hazardous substance guarantee is a guarantee of Restriction of the Use of Certain Hazardous Substances in Electrical and Electronic Equipment (RoHs).

6. A hazardous substance guarantee acquiring system for acquiring a hazardous substance guarantee of a part forming a product, comprising:
a guarantee database part configured to register information that enables a part to be specified, in correspondence with information that enables judgement as to whether or not a hazardous substance guarantee has been acquired for the part;
a merging part configured to merge a parts table indicating parts forming the product at a designing stage and a parts table indicating parts forming the product at a manufacturing stage, and to create a merged parts table;
a searching part configured to collate the parts indicated on the merged parts table and the parts guaranteed by the hazardous substance guarantees registered in the storage part, and to search the parts registered in the guarantee database part;
a judging part configured to judge whether or not there exists a part for which the hazardous substance guarantee has not been acquired, within the parts forming the product, based on a search result of the searching part; and
a requesting part configured to automatically request an issuance of the hazardous substance guarantee for the part for which the hazardous substance guarantee has not been acquired when the judging part judges that the hazardous substance guarantee has not been acquired for the part.

7. The hazardous substance guarantee acquiring system as claimed in claim 6, further comprising:
a linking part configured to acquire from a purchasing system information related to a business acquaintance that provides the part,
wherein the requesting part automatically requests the issuance of the hazardous substance guarantee for the part to the business acquaintance based on the information related to the business acquaintance.

8. The hazardous substance guarantee acquiring system as claimed in claim 7, wherein the linking part acquires information related to a new business acquaintance that provides the part, from the purchasing system, in response to a trigger that is generated when a receiver of order changes to the new business acquaintance.

9. The hazardous substance guarantee acquiring system as claimed in claim 7, wherein the linking part acquires information related to standards of the parts forming the product from a standard management system,
wherein the requesting part automatically distributes the information related to the standard of the part for which the issuance of the hazardous substance guarantee is requested to the business acquaintance based on the information related to the business acquaintance.

10. The hazardous substance guarantee acquiring system as claimed in claim 7, wherein the requesting part requests the issuance of the hazardous substance guarantee to the business acquaintance by electronic mail, facsimile, telephone or mail.

11. The hazardous substance guarantee acquiring system as claimed in claim 6, wherein:
if the part for which the issuance of the hazardous substance guarantee is requested is a specified part, the requesting part adds a flag that indicates the specified part to data of the specified part and records the data of the specified part, added with the flag, in the guarantee database part; and further comprising:
an updating part configured to reflect the data of the specified part, added with the flag, to the parts table indicating the parts forming the product at the designing stage by judging that designation of the specified part has become definite if an elapsed time from the recording of the data of the specified part, added with the flag, is a specified time or longer.

12. The hazardous substance guarantee acquiring system as claimed in claim 6, wherein the hazardous substance guarantee is a guarantee of Restriction of the Use of Certain Hazardous Substances in Electrical and Electronic Equipment (RoHs).

13. A product manufacturing method comprising:
a product planning procedure planning a product;
a developing and designing procedure developing and designing the planned product; and
a trial and actual manufacturing procedure making the developed and designed product by a trial manufacture and an actual manufacture,
wherein a hazardous substance guarantee is acquired for each of parts forming the product by a hazardous substance guarantee acquiring system in at least one of the product planning procedure, the developing and designing procedure, and the trial and actual manufacturing procedure,
the hazardous substance guarantee acquiring system comprising:
a guarantee database part configured to register information that enables a part to be specified, in correspondence with information that enables judgement as to whether or not a hazardous substance guarantee has been acquired for the part;
a merging part configured to merge a parts table indicating parts forming the product at a designing stage and a parts table indicating parts forming the product at a manufacturing stage, and to create a merged parts table;
a searching part configured to collate the parts indicated on the merged parts table and the parts guaranteed by the hazardous substance guarantees registered in the storage part, and to search the parts registered in the guarantee database part;
a judging part configured to judge whether or not there exists a part for which the hazardous substance guarantee has not been acquired, within the parts forming the product, based on a search result of the searching part; and
a requesting part configured to automatically request an issuance of the hazardous substance guarantee for the part for which the hazardous substance guarantee has not been acquired when the judging part judges that the hazardous substance guarantee has not been acquired for the part.

14. A computer-readable program for causing a computer to acquire a hazardous substance guarantee of a part forming a product, said computer being accessible to a guarantee database part configured to register information that enables a part to be specified, in correspondence with information that enables judgement as to whether or not a hazardous substance guarantee has been acquired for the part, said computer-readable program comprising:
a merging procedure causing the computer to merge a parts table indicating parts forming the product at a designing stage and a parts table indicating parts forming the product at a manufacturing stage, and to create a merged parts table;
a searching procedure causing the computer to collate the parts indicated on the merged parts table and the parts guaranteed by the hazardous substance guarantees registered in the storage part, and to search the parts registered in the guarantee database part;
a judging procedure causing the computer to judge whether or not there exists a part for which the hazardous substance guarantee has not been acquired, within the parts forming the product, based on a search result of the searching procedure; and
a requesting procedure causing the computer to automatically request an issuance of the hazardous substance guarantee for the part for which the hazardous substance guarantee has not been acquired when the judging procedure judges that the hazardous substance guarantee has not been acquired for the part.

15. The computer-readable program as claimed in claim 14, further comprising:
a linking procedure causing the computer to acquire from a purchasing system information related to a business acquaintance that provides the part,
wherein the requesting procedure causes the computer to automatically request the issuance of the hazardous substance guarantee for the part to the business acquaintance based on the information related to the business acquaintance.

16. The computer-readable program as claimed in claim 15, wherein the linking procedure causes the computer to acquire information related to a new business acquaintance that provides the part, from the purchasing system, in response to a trigger that is generated when a receiver of order changes to the new business acquaintance.

17. The computer-readable program as claimed in claim 15, wherein the linking procedure causes the computer to acquire information related to standards of the parts forming the product from a standard management system,
wherein the requesting procedure causes the computer to automatically distribute the information related to the standard of the part for which the issuance of the hazardous substance guarantee is requested to the business acquaintance based on the information related to the business acquaintance.

18. The computer-readable program as claimed in claim 15, wherein the requesting procedure causes the computer to request the issuance of the hazardous substance guarantee to the business acquaintance by electronic mail, facsimile, telephone or mail.

19. The computer-readable program as claimed in claim 14, wherein:
if the part for which the issuance of the hazardous substance guarantee is requested is a specified part, the requesting procedure causes the computer to add a flag that indicates the specified part to data of the specified part and to record the data of the specified part, added with the flag, in the guarantee database part; and further comprising:
an updating procedure causing the computer to reflect the data of the specified part, added with the flag, to the parts table indicating the parts forming the product at the designing stage by judging that designation of the specified part has become definite if an elapsed time from the recording of the data of the specified part, added with the flag, is a specified time or longer.

20. The computer-readable program as claimed in claim 14, wherein the hazardous substance guarantee is a guarantee of Restriction of the Use of Certain Hazardous Substances in Electrical and Electronic Equipment (RoHs).
